(19) United States
(12) Patent Application Publication
(10) Pub. No.: US 2015/0168339 A1
(43) Pub. Date: Jun. 18, 2015

(54) HAND-HELD TEST METER MULTI-EVENT CONTROL SOLUTION MEASUREMENT REMINDER

(71) Applicant: LifeScan Scotland Limited, Inverness-shire (GB)

(72) Inventor: Brian GUTHRIE, Inverness (GB)

(73) Assignee: LifeScan Scotland Limited, Inverness-shire (GB)

(21) Appl. No.: 14/132,994

(22) Filed: Dec. 18, 2013

(51) Int. Cl. G01N 27/327

(52) U.S. Cl. CPC G01N 27/3273; G01N 27/3272

(57) ABSTRACT

A hand-held test meter for the determination of an analyte (such as glucose) in a bodily fluid sample (for example, a whole blood sample), includes a microprocessor block, a display module, and a memory block storing multi-event control solution measurement reminder instructions and operatively coupled to the microprocessor block. Moreover, the memory block, microprocessor block and display module are configured such that the multi-event control solution measurement reminder instructions, when executed by the microprocessor block, retrieve predetermined hand-held test meter multi-event data and determine if at least one of the hand-held test meter multi-event data meets an associated predetermined condition, and if at least one of the associated predetermined conditions are met, prompt a user via the display module using, for example, a pop-up display message, to perform a control solution measurement using the hand-held test meter.

### BACKGROUND

Analyte detection in physiological fluids, e.g. blood or blood derived products, is of ever increasing importance to today's society. Analyte detection assays find use in a variety of applications, including clinical laboratory testing, home testing, etc., where the results of such testing play a prominent role in diagnosis and management in a variety of disease conditions. Analytes of interest include glucose for diabetes management, cholesterol, and the like. In response to this growing importance of analyte detection, a variety of analyte detection protocols and devices for both clinical and home use have been developed.

One type of method that is employed for analyte detection is an electrochemical method. In such methods, an aqueous liquid sample is placed into a sample-receiving chamber in an electrochemical cell that includes two electrodes, e.g., a counter and working electrode. The analyte is allowed to react with a redox reagent to form an oxidizable (or reducible) substance in an amount corresponding to the analyte concentration. The quantity of the oxidizable (or reducible) substance present is then estimated electrochemically and related to the amount of analyte present in the initial sample.

Such systems are susceptible to various modes of inefficiency or error.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1A illustrates an exemplary glucose measurement system.

FIG. 1B illustrates the various components disposed in the meter of FIG. 1A.

FIG. 1C illustrates a perspective view of an assembled test strip suitable for use in the system and methods disclosed herein;

FIG. 1D illustrates an exploded perspective view of an unassembled test strip suitable for use in the system and methods disclosed herein;

FIG. 1E illustrates an expanded perspective view of a proximal portion of the test strip suitable for use in the system and methods disclosed herein;

FIG. 2 is a bottom plan view of one embodiment of a test strip disclosed herein;

FIG. 3 is a side plan view of the test strip of FIG. 2;

FIG. 4A is a top plan view of the test strip of FIG. 3;

FIG. 4B is a partial side view of a proximal portion of the test strip of FIG. 4A;

FIG. 5 is a simplified schematic showing a test meter electrically interfacing with portions of a test strip disclosed herein;

FIG. 6A shows an example of a tri-pulse potential waveform applied by the test meter of FIG. 5 to the working and counter electrodes for prescribed time intervals;

FIG. 6B shows a current transient CT generated by a physiological sample;

FIG. 7 is a simplified block diagram of a hand-held test meter according to an embodiment of the present invention;

FIG. 8 is a simplified flow chart for a sequence of steps for a multi-event control solution measurement reminder as can be employed in embodiments of the present invention; and

FIG. 9 is a flow diagram depicting stages in a method for employing a hand-held test meter according to an embodiment of the present invention that can, for example, utilize the flow chart of FIG. 8.

### MODES FOR CARRYING OUT THE INVENTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. In addition, as used herein, the terms “patient,” “host,” “user,” and “subject” refer to any human or animal subject and are not intended to limit the systems or methods to human use, although use of the subject invention in a human patient represents a preferred embodiment. Also used herein, the phrase “electrical signal” or “signal” is intended to include direct current signal, alternating signal or any signal within the electromagnetic spectrum. The terms “processor”; “microprocessor”; or “microcontroller” are intended to have the same meaning and may be used interchangeably. As used herein, the term “annunciated” and variations on its root term indicate that an announcement may be provided via text, audio, visual or a combination of all modes or mediums of communication to a user.

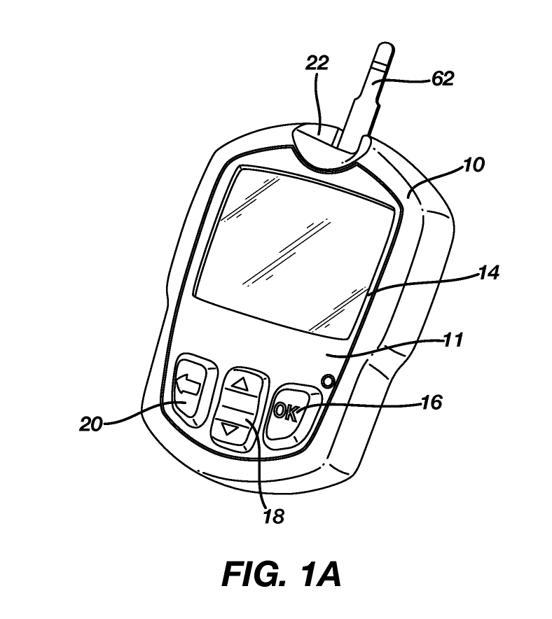

FIG. 1A illustrates a diabetes management system that includes a meter 10 and a biosensor in the form of a glucose test strip 62. Note that the meter (or, alternatively, meter unit, test meter or hand-held test meter) may be referred to as an analyte measurement and management unit, a glucose meter, a meter, and an analyte measurement device. In an embodiment, the meter unit may be combined with an insulin delivery device, an additional analyte testing device, and a drug delivery device. The meter unit may be connected to a remote computer or remote server via a cable or a suitable wireless technology such as, for example, GSM, CDMA, BlueTooth, WiFi and the like.

Referring back to FIG. 1A, glucose meter or meter unit 10 may include a housing 11, user interface buttons (16, 18, and 20), a display 14, and a strip port opening 22 to receive a biosensor or strip 62 (also referred to as a test strip or an analytical test strip). User interface buttons (16, 18, and 20) may be configured to allow the entry of data, navigation of menus, and execution of commands. User interface button 18 may be in the form of a two-way toggle switch. Alternatively, the buttons may be replaced with a touch-screen interface for display 14. Data may include values representative of analyte concentration, or information related to the everyday lifestyle of an individual. Such information may include food intake, medication use, occurrence of health check-ups, and general health condition and exercise levels of an individual.

FIG. 1B illustrates (in simplified schematic form) the electronic components disposed on a top surface of circuit board 34, which is disposed in housing 11 (FIG. 1A). On the top surface, the electronic components include a strip port connector inside the strip port opening 22, an operational amplifier circuit 35, a microcontroller 38, a display connector 14a, a non-volatile memory 40, a clock 42, and a first wireless module 46. On the bottom surface, the electronic components may include a battery connector (not shown) and a data port 13. Microcontroller 38 may be connected to strip port connector, operational amplifier circuit 35, first wireless module 46, display 14, non-volatile memory 40, clock 42, battery (not shown), data port 13, and user interface buttons (16, 18, and 20).

Operational amplifier circuit 35 may include two or more operational amplifiers configured to provide a portion of the potentiostat function and the current measurement function. The potentiostat function may refer to the application of a test voltage between at least two electrodes of a test strip. The current function may refer to the measurement of a test current resulting from the applied test voltage. The current measurement may be performed with a current-to-voltage converter. Microcontroller 38 may be in the form of a mixed signal microprocessor (MSP) such as, for example, the Texas Instrument MSP 430. The TI-MSP 430 may be configured to also perform a portion of the potentiostat function and the current measurement function. In addition, the MSP 430 may also include volatile and non-volatile memory. In another embodiment, many of the electronic components may be integrated with the microcontroller in the form of an application specific integrated circuit (ASIC).

Strip port connector may be configured to form an electrical connection to the test strip. Display connector 14a may be configured for attachment to display 14. Display 14 may be in the form of a liquid crystal display for reporting measured glucose levels, and for facilitating entry of lifestyle related information. Display 14 may also include a backlight. Data port 13 may accept a suitable connector attached to a connecting lead, thereby allowing glucose meter 10 to be linked to an external device such as a personal computer. Data port 13 may be any port that allows for transmission of data such as, for example, a serial, USB, or a parallel port. Alternatively, first wireless module 46 may also be used in place of the data port and connector to transfer data to another device. Clock 42 may be configured to keep current time related to the geographic region in which the user is located and also for measuring time. The meter unit may be configured to be electrically connected to a power supply such as, for example, a battery.

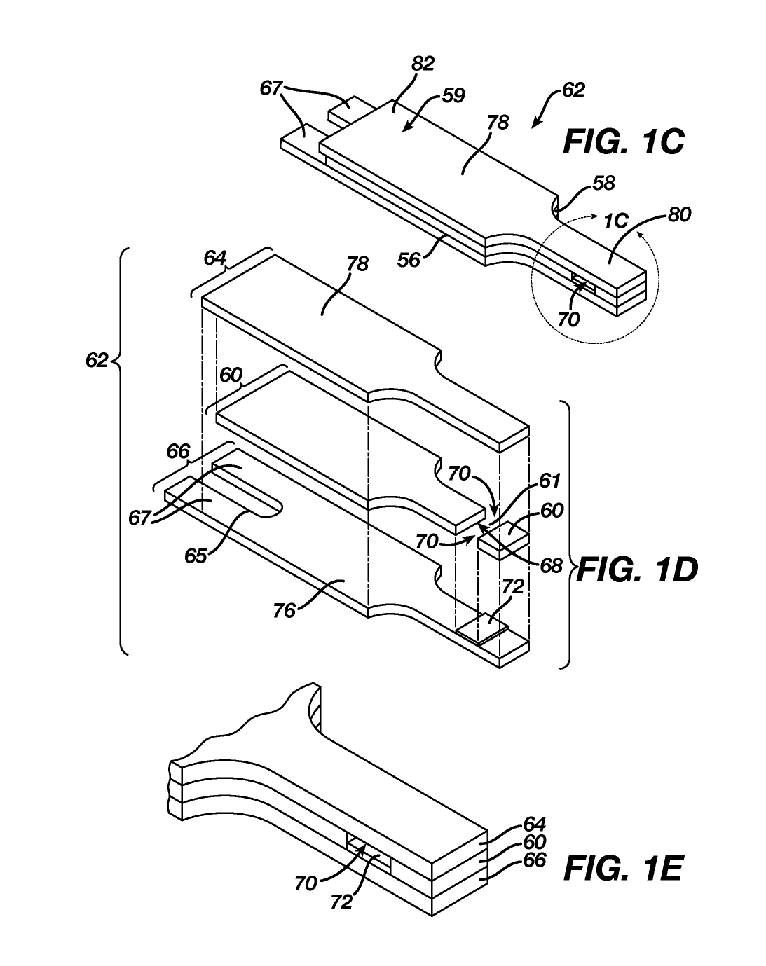

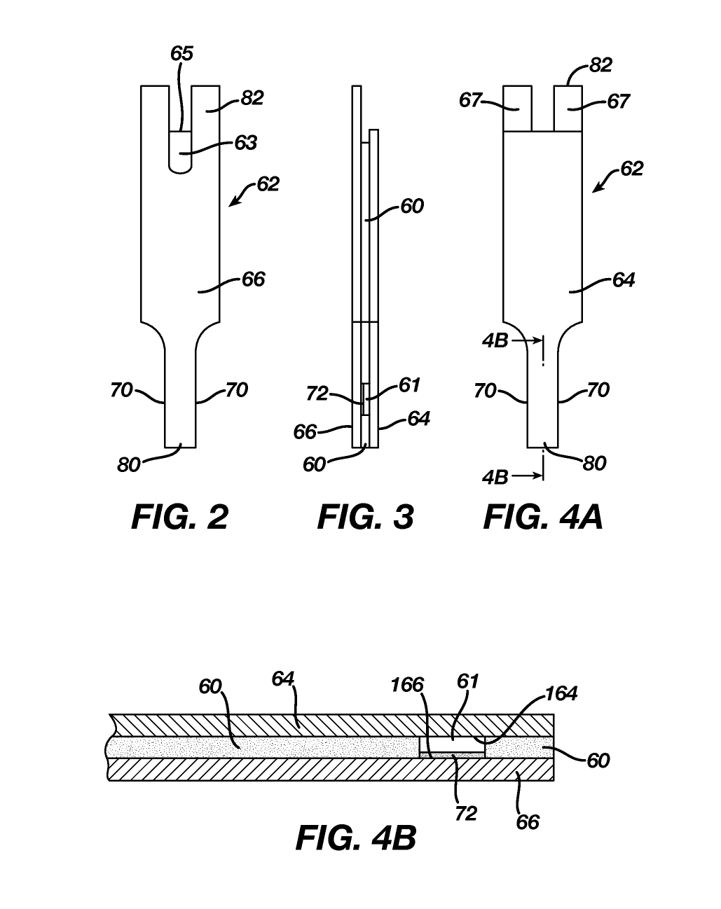

FIGS. 1C-1E, 2, 3, and 4B show various views of an exemplary test strip 62 suitable for use with the methods and systems described herein. In an exemplary embodiment, a test strip 62 is provided which includes an elongate body extending from a distal end 80 to a proximal end 82, and having lateral edges 56, 58, as illustrated in FIG. 1C. As shown in FIG. 1D, the test strip 62 also includes a first electrode layer 66, a second electrode layer 64, and a spacer 60 sandwiched in between the two electrode layers 64 and 66. The first electrode layer 66 may include a first electrode 66, a first connection track 76, and a first contact pad 67, where the first connection track 76 electrically connects the first electrode 66 to the first contact pad 67, as shown in FIGS. 1D and 4B. Note that the first electrode 66 is a portion of the first electrode layer 66 that is immediately underneath the reagent layer 72, as indicated by FIGS. 1D and 4B. Similarly, the second electrode layer 64 may include a second electrode 64, a second connection track 78, and a second contact pad 63, where the second connection track 78 electrically connects the second electrode 64 with the second contact pad 63, as shown in FIGS. 1D, 2, and 4B. Note that the second electrode 64 is a portion of the second electrode layer 64 that is above the reagent layer 72, as indicated by FIG. 4B.

As shown in FIGS. 1D and 4B, the sample-receiving chamber 61 is defined by the first electrode 66, the second electrode 64, and the spacer 60 near the distal end 80 of the test strip 62. The first electrode 66 and the second electrode 64 may define the bottom and the top of sample-receiving chamber 61, respectively, as illustrated in FIG. 4B. As illustrated in FIG. 4B A, a cutout area 68 of the spacer 60 may define the sidewalls of the sample-receiving chamber 61. In one aspect, the sample-receiving chamber 61 may include ports 70 that provide a sample inlet or a vent, as shown in FIGS. 1C to 1E. For example, one of the ports may allow a fluid sample to ingress and the other port may allow air to egress.

In an exemplary embodiment, the sample-receiving chamber 61 (also known as a “test cell” or “test chamber”) may have a small volume. For example, the sample-receiving chamber 61 may have a volume in the range of from about 0.1 microliters to about 5 microliters, about 0.2 microliters to about 3 microliters, or, preferably, about 0.3 microliters to about 1 microliter. To provide the small sample volume, the cutout area 68 may have an area ranging from about 0.01 cm² to about 0.2 cm², about 0.02 cm² to about 0.15 cm², or, preferably, about 0.03 cm² to about 0.08 cm². In addition, first electrode 66 and second electrode 64 may be spaced apart in the range of about 1 micron to about 500 microns, preferably between about 10 microns and about 400 microns, and more preferably between about 40 microns and about 200 microns. The relatively close spacing of the electrodes may also allow redox cycling to occur, where oxidized mediator generated at first electrode 66, may diffuse to second electrode 64 to become reduced, and subsequently diffuse back to first electrode 66 to become oxidized again.

In one embodiment, the first electrode layer 66 and the second electrode layer 64 may be a conductive material formed from materials such as gold, palladium, carbon, silver, platinum, tin oxide, iridium, indium, or combinations thereof (e.g., indium doped tin oxide). In addition, the electrodes may be formed by disposing a conductive material onto an insulating sheet (not shown) by a sputtering, electroless plating, or a screen-printing process. In one exemplary embodiment, the first electrode layer 66 and the second electrode layer 64 may be made from sputtered palladium and sputtered gold, respectively. Suitable materials that may be employed as spacer 60 include a variety of insulating materials, such as, for example, plastics (e.g., PET, PETG, polyimide, polycarbonate, polystyrene), silicon, ceramic, glass, adhesives, and combinations thereof. In one embodiment, the spacer 60 may be in the form of a double-sided adhesive coated on opposing sides of a polyester sheet where the adhesive may be pressure sensitive or heat activated. Various other materials for the first electrode layer 66, the second electrode layer 64, or the spacer 60 are within the spirit and scope of the present disclosure.

Either the first electrode 66 or the second electrode 64 may perform the function of a working electrode depending on the magnitude or polarity of the applied test voltage. The working electrode may measure a limiting test current that is proportional to the reduced mediator concentration. For example, if the current limiting species is a reduced mediator (e.g., ferrocyanide), then it may be oxidized at the first electrode 66 as long as the test voltage is sufficiently greater than the redox mediator potential with respect to the second electrode 64. In such a situation, the first electrode 66 performs the function of the working electrode and the second electrode 64 performs the function of a counter/reference electrode. Applicants note that one may refer to a counter/reference electrode simply as a reference electrode or a counter electrode. A limiting oxidation occurs when all reduced mediator has been depleted at the working electrode surface such that the measured oxidation current is proportional to the flux of reduced mediator diffusing from the bulk solution towards the working electrode surface. The term “bulk solution” refers to a portion of the solution sufficiently far away from the working electrode where the reduced mediator is not located within a depletion zone. It should be noted that unless otherwise stated for test strip 62, all potentials applied by test meter 10 will hereinafter be stated with respect to second electrode 64.

Similarly, if the test voltage is sufficiently less than the redox mediator potential, then the reduced mediator may be oxidized at the second electrode 64 as a limiting current. In such a situation, the second electrode 64 performs the function of the working electrode and the first electrode 66 performs the function of the counter/reference electrode.

Initially, an analysis may include introducing a quantity of a fluid sample (e.g., physiological fluid sample or calibration fluid) into a sample-receiving chamber 61 via a port 70 (FIG. 1C). In one aspect, the port 70 or the sample-receiving chamber 61 may be configured such that capillary action causes the fluid sample to fill the sample-receiving chamber 61. The first electrode 66 or second electrode 64 may be coated with a hydrophilic reagent to promote the capillary action of the sample-receiving chamber 61. For example, thiol derivatized reagents having a hydrophilic moiety such as 2-mercaptoethane sulfonic acid may be coated onto the first electrode or the second electrode to provide for such action.

In test strip 62 above, reagent layer 72 can include glucose dehydrogenase (GDH) based on the PQQ co-factor and ferricyanide. In another embodiment, the enzyme GDH based on the PQQ co-factor may be replaced with the enzyme GDH based on the FAD co-factor. When physiological fluid containing glucose (e.g., blood or control solution) is dosed into a sample-receiving chamber 61, glucose is oxidized by GDH₍ₒₓ₎ and in the process converts GDH₍ₒₓ₎ to GDH_{(red)}, as shown in the chemical reaction or transformation T.1 below. Note that GDH₍ₒₓ₎ refers to the oxidized state of GDH, and GDH_{(red)} refers to the reduced state of GDH.

D-Glucose+GDH₍ₒₓ₎→Gluconic acid+GDH_{(red)} T.1

Next, GDH_{(red)} is regenerated back to its active oxidized state by ferricyanide (i.e. oxidized mediator or Fe(CN)₆³⁻) as shown in chemical reaction T.2 below. In the process of regenerating GDH₍ₒₓ₎, ferrocyanide (i.e. reduced mediator or Fe(CN)₆⁴⁻) is generated from the reaction as shown in T.2:

GDH_{(red)}+2Fe(CN)₆³⁻→GDH₍ₒₓ₎+2Fe(CN)₆⁴⁻ T.2

Ferrocyanide generated by transformation T2 causes an electrical current to flow through the electrodes on the biosensor. The more glucose is in the fluid sample, the more gluconic acid is produced in transformation T1, increasing the electrical current generated by ferrocyanide in transformation T2.

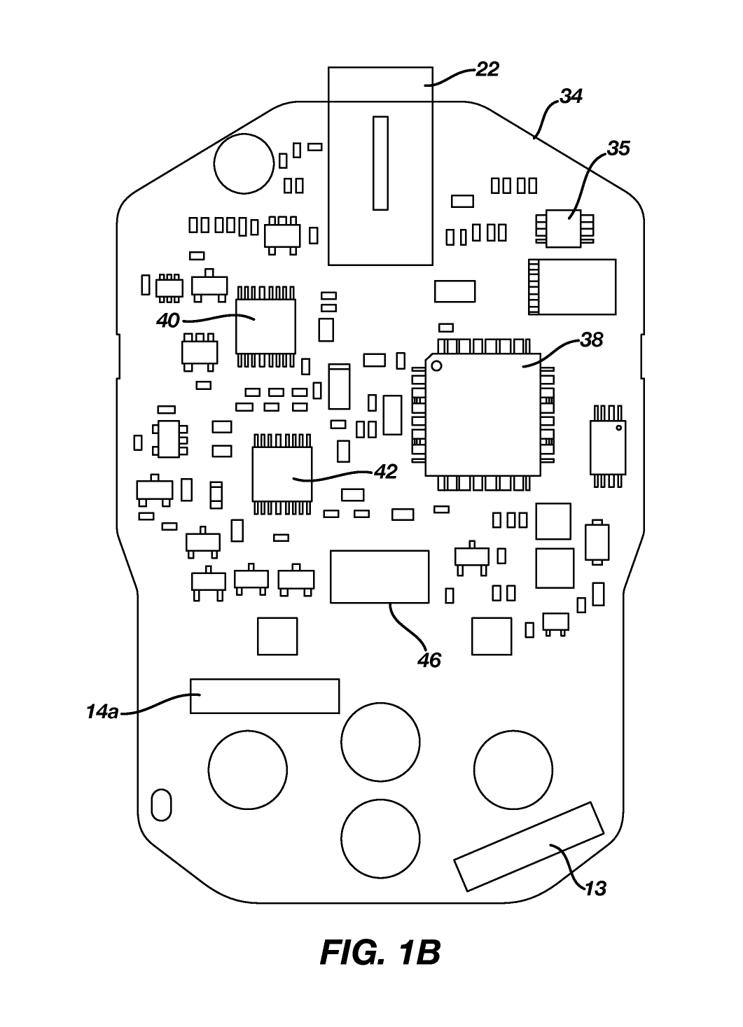

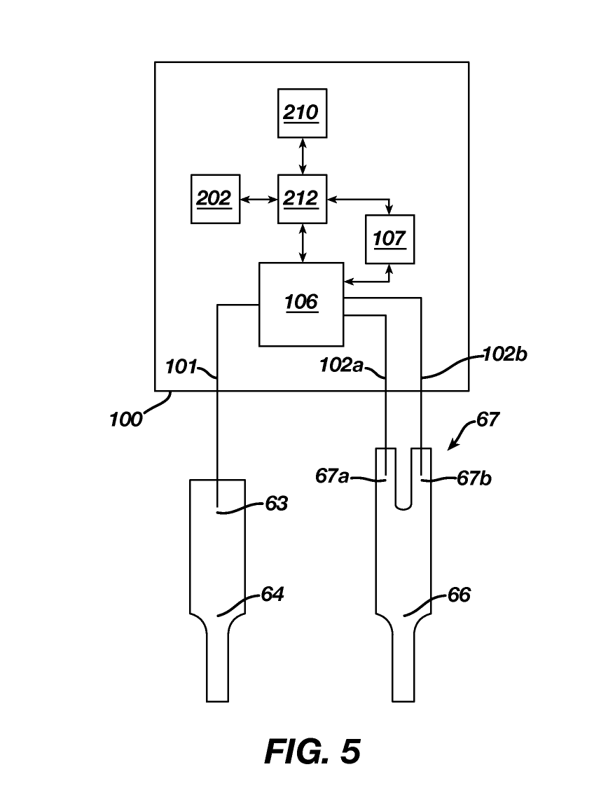

FIG. 5 provides a simplified schematic of test meter 10 in the form of measurement module 100 interfacing with a first contact pad 67a, 67b and a second contact pad 63. The second contact pad 63 may be used to establish an electrical connection to the test meter through a U-shaped notch 65, as illustrated in FIG. 2. In one embodiment, the measurement module 100 may include first electrode connectors (102a, 102b) and a second electrode connector 101 with a test voltage unit 106, a current measurement unit 107, a processor 212, a memory unit 210, and a visual display 202, as shown in FIG. 5. The first contact pad 67 may include two prongs denoted as 67a and 67b. In one exemplary embodiment, the first electrode connectors 102a and 102b separately connect to prongs 67a and 67b, respectively. The second electrode connector 101 may connect to second contact pad 63. The measurement module 100 may measure the resistance or electrical continuity between the prongs 67a and 67b to determine whether the test strip 62 is electrically connected to the test meter 10.

Meter 10 (FIGS. 1A, 1B) may include electronic circuitry that can be used to apply a plurality of voltages to the test strip 62 and to measure a current transient output resulting from an electrochemical reaction in a test chamber of the test strip 62. Meter 10 also may include a set of instructions programmed into the microprocessor to determine an analyte concentration in a fluid sample as disclosed herein.

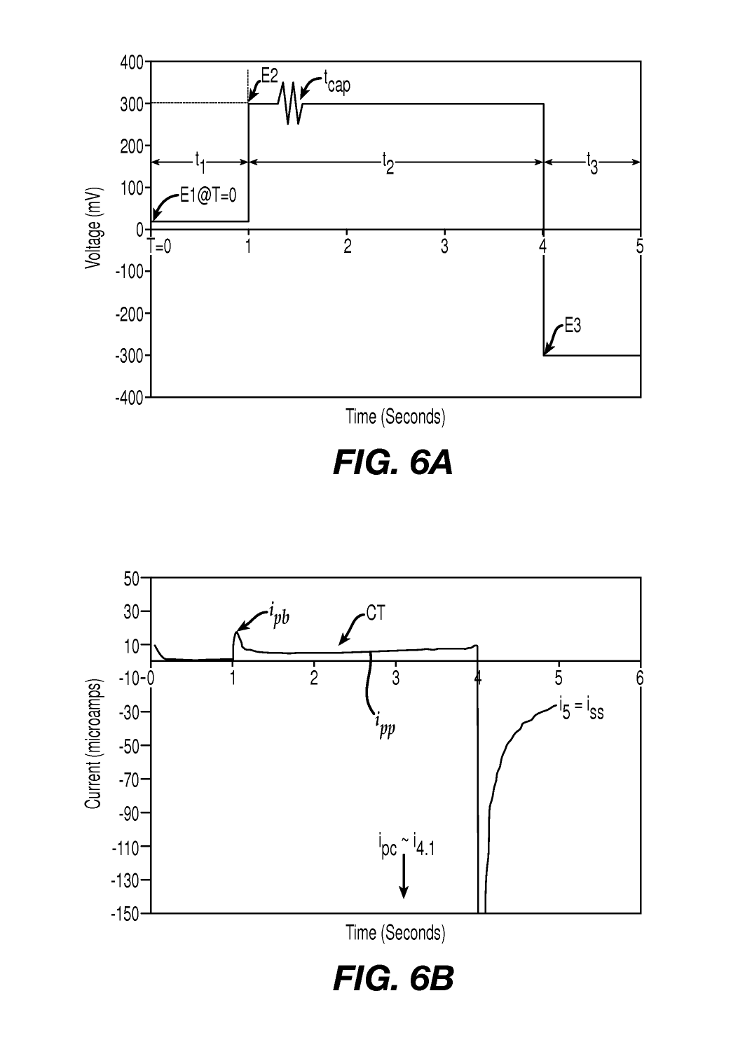

In use, the user inserts the test strip into a strip port connector of the meter 10 to connect at least two electrodes of the test strip to a strip measurement circuit. This turns on the meter 10 and meter 10 (via module 100) may apply a test voltage or a current between the first contact pad 67 and the second contact pad 63 (FIG. 5). Once the measurement module 100 recognizes that the strip 62 has been inserted, the measurement module 100 initiates a fluid detection mode. The fluid detection mode causes measurement module 100 to apply a constant current of about 1 microampere between the first electrode 66 and the second electrode 64. Because the test strip 62 is initially dry, the meter 10 measures a relatively large voltage. When the fluid sample is deposited onto the test chamber, the sample bridges the gap between the first electrode 66 and the second electrode 64 and the measurement module 100 will measure a decrease in measured voltage that is below a predetermined threshold. This causes meter 10 to automatically initiate the glucose test by application of a first electrical potential E1 (FIG. 6A).

In FIG. 6A (which has its time axis in alignment with the time axis of FIG. 6B), the analyte in the sample is transformed from one form (e.g., glucose) into a different form (e.g., gluconic acid) due to an electrochemical reaction in the test chamber that starts with initiation of the test sequence at T=0 by a test sequence timer, which timer is set by a detection of strip fill and setting the potential at E1 for a first duration of t₁. The system proceeds through the test sequence by switching the first electrical potential from E1 to a second electrical potential E2 different than the first electrical potential E1 (FIG. 6A) for a second duration t₂, then the system further changes the second potential E2 to a third electrical potential E3 different from the second electrical potential E2 (FIG. 6A) for a third duration t₃. The third electrical potential E3 may be different in the magnitude of the electromotive force, in polarity, or combinations of both with respect to the second electrical potential E2. In the preferred embodiments, E3 may be of the same magnitude as E2 but opposite in polarity.

Further, as illustrated in FIG. 6A, the second electrical potential E2 may include a direct (DC) test voltage component and a superimposed alternating (AC), or alternatively oscillating, test voltage component. The superimposed alternating or oscillating test voltage component may be applied for a time interval indicated by t_{cap}. This superimposed alternating voltage is utilized to determine if the strip has sufficient volume of the fluid sample in which to conduct a test. Details of this technique to determine sufficient volume for electrochemical testing are shown and described in U.S. Pat. Nos. 7,195,704; 6,872,298, 6,856,125, 6,797,150, which documents are incorporated by reference as if fully set forth herein.

The plurality of test current values measured during any of the time intervals may be performed at a sampling frequency ranging from about 1 measurement per microsecond to about one measurement per 100 milliseconds and preferably at about every 10 to 50 milliseconds. While an embodiment using three test electrical potentials in a serial manner is described, the glucose test may include different numbers of open-circuit and test voltages. For example, as an alternative embodiment, the glucose test could include an open-circuit for a first time interval, a second test voltage for a second time interval, and a third electrical potential for a third time interval. It should be noted that the reference to “first,” “second,” and “third” are chosen for convenience and do not necessarily reflect the order in which the test voltages are applied. For instance, an embodiment may have a potential waveform where the third electrical potential may be applied before the application of the first and second test voltages.

In this exemplary system, the process for the system may apply a first electrical potential E1 (e.g., approximately 20 mV in FIG. 6A) between first electrode 66 and second electrode 64 for a first time interval t₁ (e.g., 1 second in FIG. 6A). The first time interval t₁ may range from about 0.1 seconds to about 3 seconds and preferably range from about 0.2 seconds to about 2 seconds, and most preferably range from about 0.3 seconds to about 1.1 seconds.

The first time interval t₁ may be sufficiently long so that the sample-receiving chamber 61 may fully fill with sample and also so that the reagent layer 72 may at least partially dissolve or solvate. In one aspect, the first electrical potential E1 may be a value relatively close to the redox potential of the mediator so that a relatively small amount of a reduction or oxidation current is measured. FIG. 6B shows that a relatively small amount of current is observed during the first time interval t₁ compared to the second and third time intervals t₂ and t₃ for FIG. 6A. For example, when using ferricyanide or ferrocyanide as the mediator, the first electrical potential E1 in FIG. 6A may range from about 1 mV to about 100 mV, preferably range from about 5 mV to about 50 mV, and most preferably range from about 10 mV to about 30 mV. Although the applied voltages are given as positive in polarity in the preferred embodiments, the same voltages in the negative domain could also be utilized to accomplish the intended purpose of the present embodiments.

Referring back to FIG. 6A, after applying the first electrical potential E1, the meter 10 applies a second electrical potential E2 between first electrode 66 and second electrode 64 (e.g., approximately 300 mVolts in FIG. 6A), for a second time interval t₂ (e.g., about 3 seconds in FIG. 6A). The second electrical potential E2 may be a value different than the first electrical potential E1 and may be sufficiently negative of the mediator redox potential so that a limiting oxidation current is measured at the second electrode 64. For example, when using ferricyanide or ferrocyanide as the mediator, the second electrical potential E2 may range from about zero mV to about 600 mV, preferably range from about 100 mV to about 600 mV, and more preferably is about 300 mV.

The second time interval t₂ should be sufficiently long so that the rate of generation of reduced mediator (e.g., ferrocyanide) may be monitored based on the magnitude of a limiting oxidation current. Reduced mediator is generated by enzymatic reactions with the reagent layer 72. During the second time interval t₂, a limiting amount of reduced mediator is oxidized at second electrode 64 and a non-limiting amount of oxidized mediator is reduced at first electrode 66 to form a concentration gradient between first electrode 66 and second electrode 64.

In an exemplary embodiment, the second time interval t₂ should also be sufficiently long so that a sufficient amount of ferricyanide may be diffused to the second electrode 64 or diffused from the reagent on the first electrode. A sufficient amount of ferricyanide is required at the second electrode 64 so that a limiting current may be measured for oxidizing ferrocyanide at the first electrode 66 during the third electrical potential E3. The second time interval t₂ may be less than about 60 seconds, and preferably may range from about 1.1 seconds to about 10 seconds, and more preferably range from about 2 seconds to about 5 seconds. Likewise, the time interval indicated as t_{cap} in FIG. 6A may also last over a range of times, but in one exemplary embodiment, it has a duration of about 20 milliseconds. In one exemplary embodiment, the superimposed alternating test voltage component is applied after about 0.3 seconds to about 0.4 seconds after the application of the second electrical potential E2, and induces a sine wave having a frequency of about 109 Hz with an amplitude of about +/−50 mV.

FIG. 6B shows a relatively small peak i_{pb} after the beginning of the second time interval t₂ followed by a gradual increase of an absolute value of an oxidation current during the second time interval t₂. The small peak i_{pb} occurs due oxidation of endogenous or exogenous reducing agents (e.g., uric acid) after a transition from first electrical potential E1 to second electrical potential E2. Thereafter, there is a gradual absolute decrease in oxidation current after the small peak i_{pb}. This peak is caused by the generation of ferrocyanide by reagent layer 72, which then diffuses to second electrode 64. During the second time interval t2, a current iₚₚ can be measured from the current transient CT in the oxidation current.

After application of the second electrical potential E2, the test meter 10 applies a third electrical potential E3 between the first electrode 66 and the second electrode 64 (e.g., about −300 mVolts in FIG. 6A) for a third time interval t₃ (e.g., 1 second in FIG. 6A). The third electrical potential E3 may be a value sufficiently positive of the mediator redox potential so that a limiting oxidation current is measured at the first electrode 66. For example, when using ferricyanide or ferrocyanide as the mediator, the third electrical potential E3 may range from about zero mV to about −600 mV, preferably range from about −100 mV to about −600 mV, and more preferably is about −300 mV.

The third time interval t₃ may be sufficiently long to monitor the diffusion of reduced mediator (e.g., ferrocyanide) near the first electrode 66 based on the magnitude of the oxidation current. During the third time interval t₃, a limiting amount of reduced mediator is oxidized at first electrode 66 and a non-limiting amount of oxidized mediator is reduced at the second electrode 64. The third time interval t₃ may range from about 0.1 seconds to about 5 seconds and preferably range from about 0.3 seconds to about 3 seconds, and more preferably range from about 0.5 seconds to about 2 seconds.

FIG. 6B shows a relatively large peak i_{pc} at the beginning of the third time interval t₃ followed by a decrease to a steady-state current iₛₛ value. The measured current outputs i_{pb}, i_{pc} iₚₚ and iₛₛ can be used to determine a glucose concentration of the sample from Equation 1:

$$G = {( \frac{{i}_{ss}}{{i}_{pp}} )}^{p} \times ( a \{ \frac{{i}_{pc} + {bi}_{ss} - 2 {i}_{pb}}{{i}_{pc} + {bi}_{ss}} \} {i}_{ss} - Z ) \qquad Equation 1$$

Where G is the glucose concentration;
   iₛₛ is a magnitude of measured signals (in amperage) as a summation from about 4 seconds to about 5 seconds of the current transient
   iₚₚ is a magnitude of measured signals (in amperage) as a summation from about 1 second to about 4 seconds of the current transient;
   i_{pb} is a magnitude of measured signal (in amperage) at about 1 second of the current transient;
   i_{pc} is a magnitude of measured signal (in amperage) at about 4 seconds of the current transient;
   a is about 0.2;
   b is about 0.7
   p is about 0.5; and
   Z is about 4.
      Additional details on the biosensor system can be found in U.S. Pat. No. 8,163,162, patented Apr. 24, 2012, which is hereby incorporated by reference in its entirety into this application.

In general, hand-held test meters for the determination of an analyte (such as glucose) in a bodily fluid sample (for example, a whole blood sample) according to embodiments of the present invention include a microprocessor block, a display module, and a memory block storing multi-event control solution measurement reminder instructions and operatively coupled to the microprocessor block. Moreover, the memory block, microprocessor block and display module are configured such that the multi-event control solution measurement reminder instructions, when executed by the microprocessor block, retrieve predetermined hand-held test meter multi-event data and determine if at least one of the hand-held test meter multi-event data meets an associated predetermined condition, and if at least one of the associated predetermined conditions are met, prompt a user via the display module using, for example, a pop-up display message, to perform a control solution measurement using the hand-held test meter.

As employed herein, the term “hand-held test meter multi-event data” refers to data generated by, and/or, or programmed into, a hand-held test meter that incorporates data from multiple distinct events and, therefore, does not solely include current time data, elapsed time data or data related to a single hand-held test meter measurement. The hand-held test meter multi-event data and associated predetermined conditions are each indicative of a scenario (for example, introducing a new vial of test strips, the possibility of physical damage to the hand-held test meter, or that a user may suspect the hand-held test meter is not functioning properly) wherein a control solution measurement could beneficially verify the proper operation of the hand-held test meter. Such verification improves the overall analyte determination process by detecting improper hand-held test meter operation or reassuring a user that the hand-held test meter is operating properly.

Hand-held test meters according to embodiments of the present invention are beneficial in that, for example, they automatically prompt a user to perform a control solution measurement based an analysis of predetermined hand-held test meter multi-events and not on, for example, simple elapsed time data. Such prompts augment conventional control solution use instructions that are provided in a hand-held test meter's instruction booklet and/or on test strip labels, and are, therefore, beneficially convenient and useful to a user.

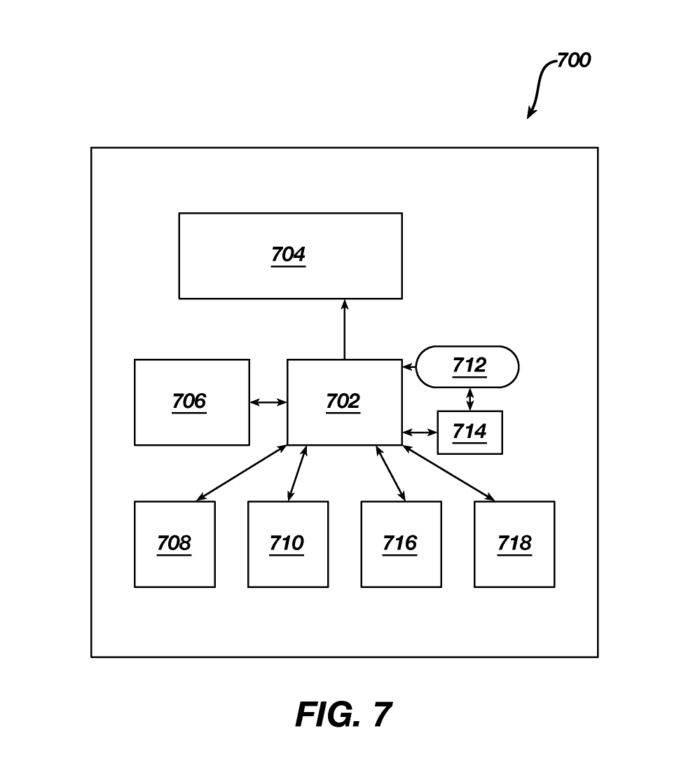

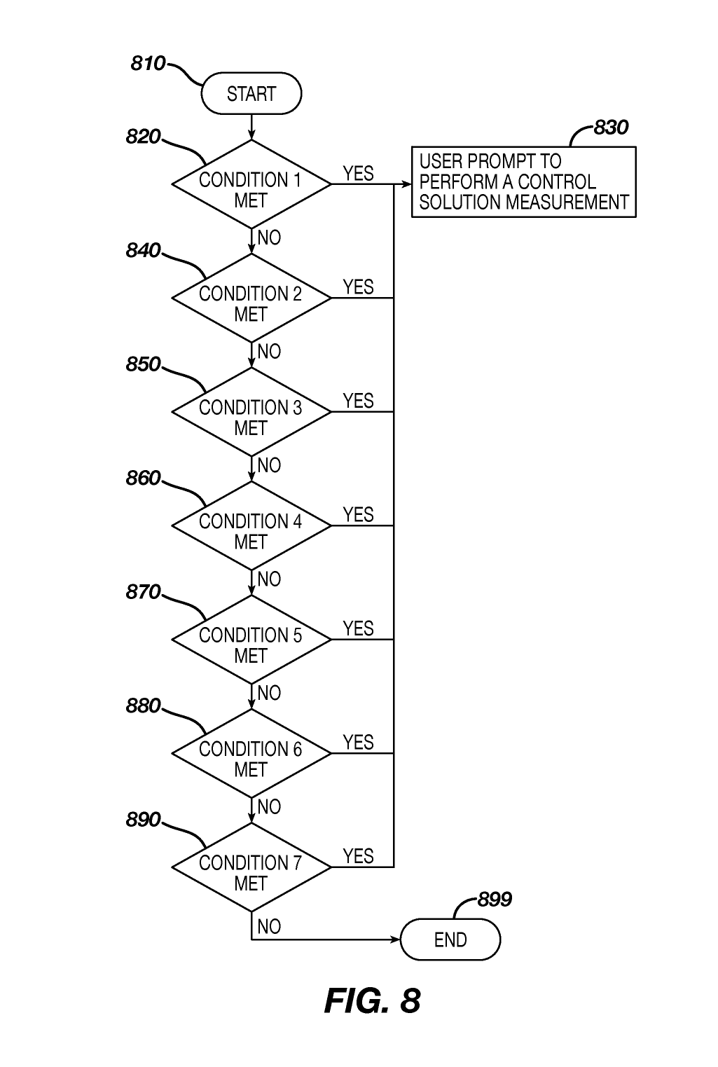

FIG. 7 is a simplified block diagram of a hand-held test meter 700 according to an embodiment of the present invention. FIG. 8 is a simplified flow chart for a sequence of steps serving as a multi-event control solution measurement reminder as can be employed in embodiments of the present invention. For brevity, FIG. 8 employs the numbering of Table 1 (described herein) to identify predetermined associated conditions that are either met (and branched along a “Yes” path of FIG. 8) or not met (and branched along a “No” path of FIG. 8).

Referring to FIGS. 7 and 8, hand-held test meter 700 includes a microprocessor block 702, a display module 704, a memory block 706, an accelerometer block 708 (e.g., a 3-axis accelerometer block such as a 3-axis accelerometer available as part number MMA8450Q from Freescale, Austin, Tex., USA), a timer block 710, a battery 712, a battery change detection block 714, a voltage monitor block 716, a test counter block 718, and other electronic components (not shown) for applying an electrical bias (e.g., an alternating current (AC) and/or direct current (DC) bias) to an electrochemical-based analytical test strip, and also for measuring an electrochemical response (e.g., plurality of test current values, phase, and/or magnitude) and determining an analyte or characteristic based on the electrochemical response.

To simplify the current descriptions, the FIG. 7 does not depict all the electronic circuitry and mechanical blocks of hand-held test meter 700. However, once apprised of the present disclosure, one skilled in the art will recognize that hand-held test meter 700 also includes further blocks and circuits required or desirable for the determination of an analyte (such as glucose) in a bodily fluid sample (for example, a whole blood sample) using, for example, an electrochemical-based analytical test strip (not shown in FIG. 7). Hand-held test meter 700 also includes circuitry (not necessarily depicted in FIG. 7) for the measurement of a control solution to validate acceptable operation of the hand-held test meter. Moreover, one skilled in the art will recognize that various blocks depicted in FIG. 7 can be integrated in any suitable manner. For example, timer block 710 and test counter block can be integrated into microprocessor block 702. In addition, one skilled in the art will recognize that predetermined hand-held test meter multi-event data generated by a block can be stored for retrieval elsewhere, for example in memory block 706.

Once one skilled in the art is apprised of the present disclosure, he or she will recognize that an example of a hand-held test meter that can be readily modified as a hand-held test meter according to the present invention is the commercially available OneTouch® Ultra® 2 glucose meter from LifeScan Inc. (Milpitas, Calif.). Additional examples of hand-held test meters that can also be modified are found in U.S. Patent Application Publications No's. 2007/0084734 (published on Apr. 19, 2007) and 2007/0087397 (published on Apr. 19, 2007) and in International Publication Number WO2010/049669 (published on May 6, 2010), and Great Britain Patent Application No. 1303616.5, filed on Feb. 28, 2013, each of which is hereby incorporated herein in full by reference.

Microprocessor block 702 can be any suitable microprocessor block known to one of skill in the art including, but not limited to, a micro-controller. Suitable micro-controllers include, but are not limited to, micro-controllers available commercially from Texas Instruments (Dallas, Tex., USA) under the MSP430 series of part numbers; from ST MicroElectronics (Geneva, Switzerland) under the STM32F and STM32L series of part numbers; and Atmel Corporation (San Jose, Calif., USA) under the SAM4L series of part numbers).

Display module 704 can be any suitable display module including, for example, a liquid crystal display or a bi-stable display configured to show a screen image. Memory block 706 is operatively coupled to the microprocessor block and the display module and stores multi-event control solution measurement reminder instructions.

Display module 704, memory block 706, and microprocessor block 702 are configured such that the multi-event control solution measurement reminder instructions, when executed by the microprocessor block, retrieve predetermined hand-held test meter multi-event data (see, for example, Table 1 herein) and, determines if at least one of the hand-held test meter multi-event data meets an associated predetermined condition (see Table 1 herein), and if at least one of the associated predetermined conditions are met, prompts a user via the display module to perform a control solution measurement using the hand-held test meter.

A representative, but non-limiting sequence of steps that can occur during the execution of multi-event control solution measurement reminder instructions is depicted in FIG. 8. The start of the sequence of FIG. 8 (block 810) is achieved, for example, by the activating (i.e., power-on) of hand-held test meter 700 or any suitable hand-held meter event such as, for example, the start of a new analyte determination test. It is particularly beneficial is the start of the sequence of FIG. 8 is achieved by the combination of activating (i.e., powering on) the hand-held test meter followed by the insertion of a test strip into the hand-held test meter. This combination avoids the processing of the sequence of FIG. 8 if a user simply turns on the hand-held test meter to review stored test results but is not preparing to run an actual test (i.e., to determine an analyte in a bodily fluid sample).

In data set and condition 1 of Table 1, data from test counter block 718 is employed and when the test count is an integer multiple of a predetermined number (e.g., the number of analytical test strips in a vial; for example, 25), the condition is considered met and the user is prompted to perform a control solution measurement (see blocks 820 and 830 of FIG. 8).

In data set and condition 2 of Table 1, data from accelerometer block 708 (such as a 3-axis accelerometer block) is employed and when such data is indicative of a dropped hand-held test meter or significant physical jolt of the hand-held test meter (e.g., sudden acceleration or deceleration) a user is prompted to perform a control solution measurement to confirm proper operation of the hand-held test meter (see blocks 840 and 830 of FIG. 8). An exemplary, but non-limiting example, of such acceleration and deceleration is an acceleration in the downward direction (I.e., z direction) of approximately 9.8 meters/sec² (indicating that the hand-held test meter is freely falling) followed by an essentially instantaneous deceleration to zero in the downward direction (indicating that the hand-held test meter has had a sudden impact).

In data set and condition 3 of Table 1, data from timer block 710 is employed along with measurement result data and when such data indicate two measurements within a predetermined time period (for example, 2 minutes) and differing by more than a predetermined amount (for example, 20 mg/dL). A user is prompted to perform a control solution measurement to confirm proper operation of the hand-held test meter (see blocks 850 and 830 of FIG. 8). In data set and condition 4 of Table 1, data from timer block 710 is also employed along with measurement result data and when such data indicates more than two measurements within a predetermined time period (for example, 5 minutes) and differing by less a predetermined amount (for example, 10 mg/dL), a user is prompted to perform a control solution measurement to confirm proper operation of the hand-held test meter (see blocks 860 and 830 of FIG. 8). Both of these scenarios, i.e., multiple determinations within a short time period that either differ significantly or are essentially identical can be indications that the user suspects the hand-held test meter is operating in a faulty manner. Prompting the user to run a control solution measurement will either dispel this belief or confirm it.

In data set and condition 5 of Table 1, a first time use flag is employed to trigger a user prompt (see blocks 870 and 830 of FIG. 8) while in data set and condition 6 of Table 1, battery change indication data (from battery change detection block 714) is employed to trigger a user prompt (see blocks 880 and 830 of FIG. 8).

In data set and condition 7 of Table 1, data from voltage monitor block 716 is employed when such data indicate indicates a voltage upset and subsequent hand-held test meter reset a user is prompted to perform a control solution measurement to confirm proper operation of the hand-held test meter (see blocks 890 and 830 of FIG. 8). If none of the conditions of Table 1 are met, the sequence of events of FIG. 8 comes to an end (see block 899 of FIG. 8) and the sequence is not repeated until conditions for the start of block 810 are again met. When the start is conditioned on a combination of powering on the hand-held test meter and insertion of an analytical test strip, the sequence of FIG. 8 will run only once following this combination.

Block 830 of FIG. 8 represents the hand-held test meter prompting a user to perform a control solution test. Such a prompt can be generic in nature (meaning that the same prompt is employed when any of conditions 1 through 7 are met or the prompt can be specific to a one or more conditions being met. For example, the prompt for condition 5 can be a message stating “Reminder—the first test should be performed using control solution, see owner's manual for details,” or the prompt for condition 2 can be a message stating “Warning, it seems your meter may have been dropped, please perform a control solution test” and the prompt for condition 1 can be a message stating “Reminder—it is recommended to perform a control solution test with each new vial of test strips.”

The sequence of events depicted in FIG. 8 branches to event 830 following any of the conditions being met. However, since a user can choose to ignore any given prompt and not run a control solution measurement, a first alternative sequence would test all conditions (such conditions 1 through 7 of Table 1) and then prompt a user if at least one of the conditions were met to insure that all conditions are checked. A second alternative would loop back to the next condition in the sequence if a user chooses to ignore a prompt, thus enabling a check of all conditions should a user ignore any and all prompts.

Once apprised of the present disclosure, a variety of suitable predetermined hand-held test meter multi-event data and associated predetermined conditions can be devised by one skilled in the art. In this regard, the following table includes 7 sets of predetermined hand-held test data and associated predetermined conditions have been found to be particularly beneficial as members of a multi-event data. All 7 of these sets can be combined (as depicted in FIG. 8), or a sub-set can be employed.

TABLE 1

| Data Set & | | |
|---|---|---|
| Condition | | |
| Number | Data Type | Associated Predetermined Condition |
| 1 | Hand-held test meter | Test counter equals an integer when divided |
| | test count data | by a predetermined number (e.g., 25 when |
| | | test strips are supplied in vials containing 25 test |
| | | strips) |
| 2 | Accelerometer output | Accelerometer output data is indicative of a |
| | data | dropped hand-held test meter or significant |
| | | physical jolt of the hand-held test meter (e.g., |
| | | sudden acceleration or deceleration) |
| 3 | Meter measurement | Measurement timinq and result data indicate |
| | timing and result data | two measurements within a predetermined |
| | | time period and differing by more than a |
| | | predetermined amount. |
| 4 | Meter measurement | Measurement timing and result data indicate |
| | timing and result data | more than two measurements within a |
| | | predetermined time period and differing by |
| | | less than a predetermined amount. |
| 5 | Hand-held test meter | First time use flag data indicates hand-held |
| | first time use flag data | test meter is being used for the first time |
| | | following power on (i.e., activation). |
| 6 | Battery change | Battery change indicator data indicates a |
| | indicator data | battery change has occurred since the latest |
| | | prior measurement. |
| 7 | Hand-held test meter | Voltage disturbance indicator data indicates a |
| | reset due to voltage | voltage upset and subsequent hand-held test |
| | disturbance indicator | meter reset |
| | data | |

The sequence of steps of a multi-event control solution measurement reminder as described herein can be wholly or partially may be embodied in a hand-held test meter as software including, for example, software (also known as a computer program) developed using suitable programming language known to one skilled in the art including, for example, an object oriented language, C language, C++ language, or a micro-controller code such as assembly language. Moreover, the required software can, for example, be stored in an independent memory block, or in a memory block integrated within a microprocessor block.

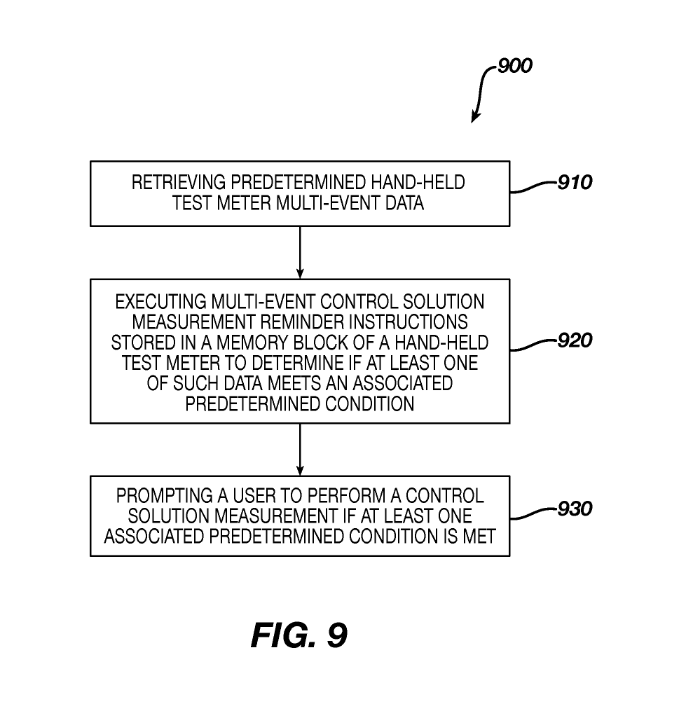

FIG. 9 is a flow diagram depicting stages in a method 900 for employing a hand-held test meter for the determination of an analyte (e.g., glucose) in a bodily fluid sample (for example, a whole blood sample) according to an embodiment of the present invention. Referring to FIG. 9, at step 910, method 900 includes retrieving, using a memory block and a microprocessor block of the hand-held test meter, predetermined hand-held test meter multi-event data.

Method 900 also includes determining, by executing multi-event control solution measurement reminder instructions stored in the memory block, if at least one of the hand-held test meter multi-event data meets an associated predetermined condition (see step 920 of FIG. 9). The multi-event control solution instructions stored in the memory block can, for example, be instructions that perform the sequence of steps illustrated by the simplified flow chart of FIG. 8. Method 900 also includes prompting, via a display module of the hand-held test meter, a user to perform a control solution measurement using the hand-held test meter upon determination that at least one of the associated predetermined conditions is met. Such prompting noted depicted in step 930 of FIG. 9 and can involve, for example, the use of a pop-up message on the display module of the hand-held test meter.

Once apprised of the present disclosure, one skilled in the art will recognize that methods according to embodiments of the present invention, including method 900, can be readily modified to incorporate any of the techniques, benefits and characteristics of hand-held test meters according to embodiments of the present invention and described herein.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. A hand-held test meter for the determination of an analyte in a bodily fluid sample, the hand-held test meter comprising:
a microprocessor block;
a display module; and
a memory block operatively coupled to the microprocessor block and the display module and storing multi-event control solution measurement reminder instructions,
wherein the display module, memory block, and microprocessor block are configured such that the multi-event control solution measurement reminder instructions, when executed by the microprocessor block, retrieve predetermined hand-held test meter multi-event data and, determine if at least one of the hand-held test meter multi-event data meets an associated predetermined condition, and if at least one of the associated predetermined conditions are met, prompts a user via the display module to perform a control solution measurement using the hand-held test meter.

2. The hand-held test meter of claim 1 further including a test counter module.

3. The hand-held test meter of claim 2 wherein the hand-held test meter event data includes test counter data that includes a test count and the associated predetermined condition for the test counter data is when the test count divided by a predetermined number is an integer.

4. The hand-held test meter of claim 3 wherein the predetermined number is twenty-five.

5. The hand-held test meter of claim 1 further including an accelerometer module.

6. The hand-held test meter of claim 5 wherein the hand-held test meter event data includes accelerometer output data and the associated predetermined condition for the accelerometer output data is accelerometer output data that is indicative of possible damage to the hand-held test meter.

7. The hand-held test meter of claim 1 further including a meter measurement timing block.

8. The hand-held test meter of claim 7 wherein the hand-held test meter event data includes meter measurement timing data and the associated predetermined condition for the meter measurement timing data is two measurements within a predetermined time period and differing by more than a predetermined amount.

9. The hand-held test meter of claim 7 wherein the hand-held test meter event data includes meter measurement timing data and the associated predetermined condition for the meter measurement timing data is more than two measurements within a predetermined time period and differing by less than a predetermined amount.

10. The hand-held test meter of claim 1 further including a battery change detection block.

11. The hand-held test meter of claim 7 wherein the hand-held test meter event data includes battery change indicator data and the associated predetermined condition is battery change indicator data indicative of a batter change.

12. The hand-held test meter of claim 1 further including a voltage monitor block.

13. The hand-held test meter of claim 12 wherein the hand-held test meter event data includes voltage disturbance indicator data and the associated predetermined condition indicates a voltage upset and subsequent hand-held test meter reset.

14. The hand-held test meter of claim 1 further including a first time use flag block.

15. The hand-held test meter of claim 12 wherein the hand-held test meter event data includes first time use flag data following activation of the hand-held test meter and the associated predetermined condition is the hand-held test meter is being used for the first time following power on.

16. The hand-held test meter of claim 1 wherein the memory block, microprocessor block and display module are configured such that a user can disregard the prompt.

17. The hand-held test meter of claim 1 wherein the memory block, microprocessor block and display module are configured to prompt a user via a pop-up message on the display module that prompts a user to perform a control solution measurement using the hand-held test meter.

18. The hand-held test meter of claim 1 wherein the analyte is glucose and the bodily fluid sample is a whole blood sample.

19. The hand-held test meter of claim 1 wherein the prompt is generic in nature.

20. The hand-held test meter of claim 1 wherein the prompt is specific to one or more predetermined conditions.

21. The hand-held test meter of claim 1 wherein the hand-held test meter is configured such that the multi-event control solution measurement reminder instructions are executed by the microprocessor block when a combination of the hand-held test meter being activated and an analytical test strip being inserted into the hand-held test meter occurs.

22. A method for employing a hand-held test meter for the determination of an analyte in a bodily fluid sample, the method comprising:
retrieving, using a memory block and a microprocessor block of the hand-held test meter, predetermined hand-held test meter multi-event data;
determining, by executing multi-event control solution measurement reminder instructions stored in the memory block, if at least one of the hand-held test meter multi-event data meets an associated predetermined condition; and
prompting, via a display module of the hand-held test meter, a user to perform a control solution measurement using the hand-held test meter upon determination that at least one of the associated predetermined condition is met.

23. The method of claim 22 wherein the hand-held test meter further includes a test counter module, and
wherein the hand-held test meter event data includes test counter module data that includes a test count and the associated predetermined condition for the test counter module data is when the test count divided by a predetermined number is an integer.

24. The method of claim 23 wherein the predetermined number is twenty-five.

25. The method of claim 22 wherein the hand-held test meter further includes an accelerometer module, and
wherein the hand-held test meter event data includes accelerometer module output data and the associated predetermined condition for the accelerometer output module data is accelerometer output data that is indicative of possible damage to the hand-held test meter.

26. The method of claim 22 wherein the hand-held test meter further includes a meter measurement timing block, and
wherein the hand-held test meter event data includes meter measurement timing block data and the associated predetermined condition for the meter measurement timing block data is two measurements within a predetermined time period and differing by more than a predetermined amount.

27. The method of claim 22 wherein the hand-held test meter further includes a meter measurement timing block, and
wherein the hand-held test meter event data includes meter measurement timing block data and the associated predetermined condition for the meter measurement timing block data is more than two measurements within a predetermined time period and differing by less than a predetermined amount.

28. The method of claim 22 wherein the hand-held test meter includes a battery change detection block, and
wherein the hand-held test meter event data includes battery change indicator data and the associated predetermined condition is battery change indicator data indicative of a batter change.

29. The method of claim 22 wherein the hand-held test meter includes a voltage monitor block, and
wherein the hand-held test meter event data includes voltage monitor data and the associated predetermined condition is indicative of a voltage upset and subsequent hand-held test meter reset.

30. The method of claim 22 wherein the hand-held test meter further includes a first time use flag block, and
wherein the hand-held test meter event data includes first time use flag data following activation of the hand-held test meter and the associated predetermined condition is the hand-held test meter is being used for the first time following activation.

31. The method of claim 22 wherein the memory block, microprocessor block and display module are configured such that a user can disregard the prompt.

32. The method of claim 22 wherein the memory block, microprocessor block and display module are configured to prompt a user via a pop-up message on the display module that prompts a user to perform a control solution measurement using the hand-held test meter.

33. The method of claim 22 wherein the analyte is glucose and the bodily fluid sample is a whole blood sample.

34. The method of claim 22 wherein the prompt is generic in nature.

35. The method of claim 22 wherein the prompt is specific to one or more predetermined conditions.

36. The method of claim 22 wherein the hand-held test meter is configured such that the multi-event control solution measurement reminder instructions are executed by the microprocessor block when a combination of the hand-held test meter being activated and an analytical test strip being inserted into the hand-held test meter.
